(19) United States
(12) Patent Application Publication
(10) Pub. No.: US 2008/0271277 A1
(43) Pub. Date: Nov. 6, 2008

(54) Rubber product for wiping, rubber for wiper blade, method for producing rubber for wiper blade, and wiper unit

(75) Inventors: Norihito Mizote, Kiryu-shi (JP); Akio Katakai, Takasaki-shi (JP); Masao Tamada, Takasaki-shi (JP)

Correspondence Address: OLIFF & BERRIDGE, PLC, P.O. BOX 320850, ALEXANDRIA, VA, 22320-4850, US

(73) Assignees: MITSUBA CORPORATION, KIRYU-SHI (JP); INDEPENDENT ADMINISTRATIVE INSTITUTION JAPAN ATOMIC ENERGY AGENCY, NAKA-GUN (JP)

(21) Appl. No.: 12/081,819

(22) Filed: Apr. 22, 2008

(30) Foreign Application Priority Data
Apr. 27, 2007 (JP) 2007-118068
Mar. 18, 2008 (JP) 2008-069150

(51) Int. Cl. B60S 1/38; C08L 51/04; C08F 2/46

(52) U.S. Cl. 15/250.48; 525/78; 427/487

(57) ABSTRACT

A rubber product for wiping, a rubber for a wiper blade, a method for producing a rubber for a wiper blade, and a wiper unit. The rubber product for wiping, for example, includes a hydrophilic gel-like surface treatment layer coated on at least a wiping surface of the rubber product, wherein the wiping surface is softer due to water absorption when moistened than when dried.

### CROSS-REFERENCE TO RELATED APPLICATION

This application claims priority from Japanese Patent Application No. 2007-118068 filed Apr. 27, 2007 and Japanese Patent Application No. 2008-069150 filed Mar. 18, 2008, the entire disclosures of which are incorporated herein by reference hereto.

### BACKGROUND

The present invention relates to a rubber product for wiping, a rubber for a wiper blade, a method for producing a rubber for a wiper blade, and a wiper unit.

There exist rubber products for wiping that are used for wiper blades that wipe window glasses of vehicles, for example. In order for such rubbers to be used, a wiper system must be designed in consideration of the frictional resistance that exists during dry conditions. In order to lower such frictional resistance, a proposed rubber is hardened on its surface by chlorine treatment (see Japanese Published Unexamined Patent Application No. S59-139926 and Japanese Published Unexamined Patent Application No. H05-320394, for example). Another proposed rubber is hardened on its surface by impregnation with isocyanurate treatment liquids (see Japanese Published Unexamined Patent Application No. 2002-161154, for example). When the rubber surface is hardened, a hardened layer is generated on the rubber surface. Friction can be reduced because of the hardened layer.

### SUMMARY

A wiping performance of the hardened rubbers, however, may be deteriorated because of small cracks that may also be generated by the surface hardening. The rubbers ability to follow friction surfaces may also be lowered because of the highly hardened surface of the rubbers. In other words, the friction reduction by the surface hardening may cause lowered wiping performances, and lowered friction is difficult to realize with heightened wiping performances at higher levels.

In addition, in order to reduce the friction of the wiper blade, a coating material, such as a powder, is widely used that is low in sliding performance and coats the rubber surface. Such powder, however, obstructs a close contact between the rubber and the glass. The wiping performance is thus lowered. Furthermore, because adhesion is weak between the coating material and the rubber, the coated powder cannot last long. The present disclosure solves the problem as well as other problems and is also able to achieve various advantages.

In view of these circumstances, an exemplary aspect of the present invention includes a rubber product for wiping that includes a hydrophilic gel-like surface treatment layer coated on at least a wiping surface of the rubber product, wherein the wiping surface is softer due to water absorption when moistened than when dried.

According to another exemplary aspect of the present invention, a surface wiped by the wiping surface is a glass surface, and the hydrophilic gel-like surface treatment layer has a hydrophilic hydrogel layer.

An exemplary aspect of the present invention includes a rubber for a wiper blade that includes a hydrophilic gel-like surface treatment layer coated on at least a wiping surface of the rubber, wherein the wiping surface is softer due to water absorption when moistened than when dried.

According to another exemplary aspect of the present invention, a surface wiped by the wiping surface is a glass surface, and the hydrophilic gel-like surface treatment layer has a hydrophilic hydrogel layer.

According to another exemplary aspect of the present invention, the wiping surface of the rubber is subjected to a hydrophilic gel-like surface treatment by forming active sites on the wiping surface of the rubber and reacting the active sites with a surface preparation agent.

According to another exemplary aspect of the present invention, a hydrophilic gel-like surface treatment is applied by forming active sites in a surface preparation agent and reacting the active sites with the wiping surface.

According to another exemplary aspect of the present invention, the hydrophilic gel-like surface treatment is a treatment with a gel-like substance with a hydrophilic property.

According to another exemplary aspect of the present invention, a gel-like substance with a hydrophilic property of a surface preparation agent is chemically bonded to the wiping surface by graft polymerization.

According to another exemplary aspect of the present invention, the gel-like substance with the hydrophilic property is a graft polymer using at least one hydrophilic monomer such as hydroxyethylmethacrylate, hydroxyethylacrylate, glycidyl methacrylate, acrylamide, methacrylic acid, acrylic acid, and metal salts of these.

According to another exemplary aspect of the present invention, the hydrophilic monomer is a reactive monomer having at least one of a vinyl group, an isopropenyl group, and an allyl group in a molecule, and in the molecule, having hydrophilic substituents or chemical bonds represented by a hydroxyl group, thiol group, carbonyl group, carboxyl group, aldehyde group, ketone group, amino group, epoxy group, cyano group, isocyanate group, nitro group, halogen group, sulfonyl group, phosphate group, ionic substituent, and ester bond, ether bond, amide bond, and urethane bond, or having a functional group into which at least one of the substituents or chemical bonds can be introduced by further reaction after graft polymerization.

According to another exemplary aspect of the present invention, an initial state of the wiping surface for graft polymerization is irradiated with an activating radiation source for activating the wiping surface.

According to another exemplary aspect of the present invention, the wiping surface irradiated with the activating radiation source is graft polymerized with a hydrophilic monomer.

According to another exemplary aspect of the present invention, the activating radiation source is a radiation source that evokes activation represented by alpha beam, beta beam, gamma beam, electron beam, ultraviolet ray, x-ray, laser beam, plasma, ion beam, and corona.

According to another exemplary aspect of the present invention, when the activating radiation source is an electron beam, an absorbed dose thereof is not less than 5 kGy, and a reactive solution concentration of the hydrophilic monomer in the graft polymerization is not less than 3 weight percent.

According to another exemplary aspect of the present invention, the graft polymerization uses, as an initiating reagent, at least one of the chemical substances represented by peroxides, azo compounds, redox initiators, alkali metals, organic alkali metals, and Grignard reagents.

An exemplary aspect of the present invention includes a method for producing a rubber for a wiper blade that includes applying a hydrophilic gel-like surface treatment to at least a wiping surface of the rubber in order to make the wiping surface hard when dried and soft due to water absorption when moistened, wherein the hydrophilic gel-like surface treatment is a treatment with a gel-like substance with a hydrophilic property.

According to another exemplary aspect of the present invention, the hydrophilic gel-like surface treatment chemically bonds the gel-like substance with the hydrophilic property to the wiping surface by graft polymerization.

According to another exemplary aspect of the present invention, the graft polymerization is performed after irradiating the wiping surface for the graft polymerization with an activating radiation source for activating the wiping surface.

According to another exemplary aspect of the present invention, the wiping surface irradiated with the activating radiation source is graft polymerized with a hydrophilic monomer.

An exemplary aspect of the present invention includes a wiper unit that includes a wiper arm; a rubber holder attached to the wiper arm; and a blade rubber that wipes a window glass surface of a vehicle. The blade rubber includes a head portion, a joint portion that is formed continuously from the head portion and is held by the rubber holder, wherein the joint portion has a width in a wiping direction narrower than that of the head portion, a neck portion that is formed continuously from the joint portion and is held by the rubber holder, wherein the neck portion has a width in the wiping direction narrower than that of the joint portion, and a lip portion that is formed continuously from the neck portion, wherein at least a wiping surface of the lip portion is coated with a gel-like substance with a hydrophilic property that makes the wiping surface softer due to water absorption when moistened than when dried.

According to another exemplary aspect of the present invention, the gel-like substance with the hydrophilic property adheres to both side surfaces in the wiping direction of the lip portion of the blade rubber, and the gel-like substance with hydrophilic property is not adhering to a cut surface of the lip portion of the blade rubber.

According to exemplary aspects of the present invention, the rubber wiping surface is softened by coming into contact with water and absorbing water when wiping, so that the surface hardness in a wet state is lowered, and when dried, the hardness quickly restores to the original hardness. A low friction equivalent to that of a rubber surface subjected to chlorine treatment can be achieved, a lowered wiping performance can be suppressed and excellent wear resistance can be obtained while realizing the low friction.

### BRIEF DESCRIPTION OF THE DRAWINGS

Various exemplary embodiments of the present invention will be described with reference to the drawings, wherein:

FIG. 1 is a perspective view showing a usage state of a wiper blade as an embodiment of the present invention;

FIG. 2A is a sectional view along the A-A line of FIG. 1, and FIG. 2B is an enlarged view of a lip portion of FIG. 2A;

FIG. 3A and FIG. 3B are explanatory views showing details of a holding portion of the rubber holder shown in FIGS. 2A and 2B;

FIG. 4 is an explanatory view showing a reaction form of the pre-irradiation;

FIG. 5 is an explanatory view showing a reaction form of the simultaneous irradiation;

FIG. 6 is a table showing the results of measurements of the graft ratio, the absorbance ratio, the surface hardness, and the contact angle of rubber irradiated with an electron beam according to the simultaneous irradiation method while impregnated with HEMA;

FIGS. 7A-7D are graphs showing the results of FIG. 6;

FIG. 8A and FIG. 8B are a table and a graph showing the surface hardnesses in a dry state and a wet state after grafting;

FIG. 9 is a table showing changes in surface hardness during transition from a wet state to a dry state;

FIG. 10 is a graph showing changes in surface hardness during transition from a wet state to a dry state when the absorbed dose was set to 20 kGy;

FIG. 11A and FIG. 11B are a table of measured frictional properties of rubber and a graph showing frictional coefficients in a dry state;

FIG. 12 is a graph showing the relationship between changes in frictional coefficient and wiping performance according to surface treatment; and

FIG. 13 is a graph showing the relationship between the graft ratio and the wearing section of graft-polymerized rubber.

### DETAILED DESCRIPTION OF EMBODIMENTS

Next, an embodiment of the present invention will be described. The present invention relates to a rubber product for wiping such as a blade rubber for wiping a window surface, a rubber for a wiper blade, a method for producing a rubber for a wiper blade, and a wiper unit.

A rubber product for wiping of the present invention is used as a rubber for a wiper blade, and in this case, a wiping surface of the rubber is subjected to hydrophilic gel-like surface treatment that hardens the surface when dried other than moistened states as in the case of raining, and softens the surface according to water absorption when moistened. The surface preparation agent lowers in dry friction resistance with glass due to its high hardness when dried, and softens the surface due to water absorption and increases its performance of following glass when moistened. Accordingly, a low friction when dried and excellent raindrop wiping performance are both realized, and a window surface can be smoothly wiped.

As a method for such surface treatment, a hydrophilic gel-like surface treatment can be applied by forming active sites on the surface of the rubber for a wiper blade and reacting the active sites with a surface preparation agent, and hydrophilic gel-like surface treatment can be applied by forming active sites in a surface preparation agent and chemically treating the active sites and reacting them with the rubber surface.

In this case, hydrophilic gel-like surface treatment is a treatment with a gel-like substance with a hydrophilic property, and the surface preparation agent contains a gel-like substance with a hydrophilic property chemically bonded to the rubber surface by graft polymerization.

The present invention realizes both low friction and high wiping performance, and focuses on the fact that a situation where the friction comes into question and a situation where the wiping performance comes into question are different from each other. Specifically, the present invention was approached on the basis of an assumption that the problems could be solved by using a hydrogel layer with high hydrophilic property for coating by setting up a hypothesis that low friction and high wiping performance could be both realized by assuming a coating material that was low in hardness in a wet state that the wiping performance came into question and applying a coating that changed the surface hardness depending on the situation by using this coating material.

A typical gel component is a graft polymer of hydrophilic monomers such as hydroxyethylmethacrylate, hydroxyethylacrylate, glycidyl methacrylate, acrylamide, methacrylic acid, acrylic acid, and metal salts of these.

Hydrophilic hydrogel has a property of softening when it absorbs water although it is hard in a dried state, and it is deduced that by coating this hydrophilic hydrogel layer on the wiper blade, the gel-like layer that is dry at the time of dry friction becomes high in hardness. Accordingly, the friction can be reduced, and on the other hand, the gel-like layer swells in a wet state when wiping raindrops to lower the hardness, and accordingly, adhesion to glass is improved and excellent wiping performance is obtained. In this case, by using a coating layer obtained by chemically bonding a hydrophilic hydrogel layer by graft polymerization, the coating layer and the rubber surface are integrated and excellent in durability so as to hardly separate from each other.

As rubber to be used in the present invention, rubber normally known can be used. For example, natural rubber (NR), isoprene rubber (IR), butadiene rubber (BR), styrene-butadiene copolymer rubber (SBR), acrylonitrile-butadiene copolymer rubber (NBR), chloroprene rubber (CR), fluorine-containing rubber (FKM), butyl rubber (IIR), ethylene-propylene copolymer rubber (EPM), ethylene-propylene-diene terpolymer rubber (EPDM), hydrated nitrile rubber (hydrated NBR), silicone rubber, epichlorohydrin rubber (CO, ECO), polysulfide rubber (T), and urethane rubber (U) can be used by way of example singly or by mixing a plurality of rubber types among these. A blade rubber is produced by vulcanizing the above-described rubber material blended with normally known additives such as a vulcanizing agent, a vulcanization accelerator, a softener, an antioxidant, a filler, a silane coupling agent, silica, and carbon black according to a conventionally known method such as pressure vulcanization.

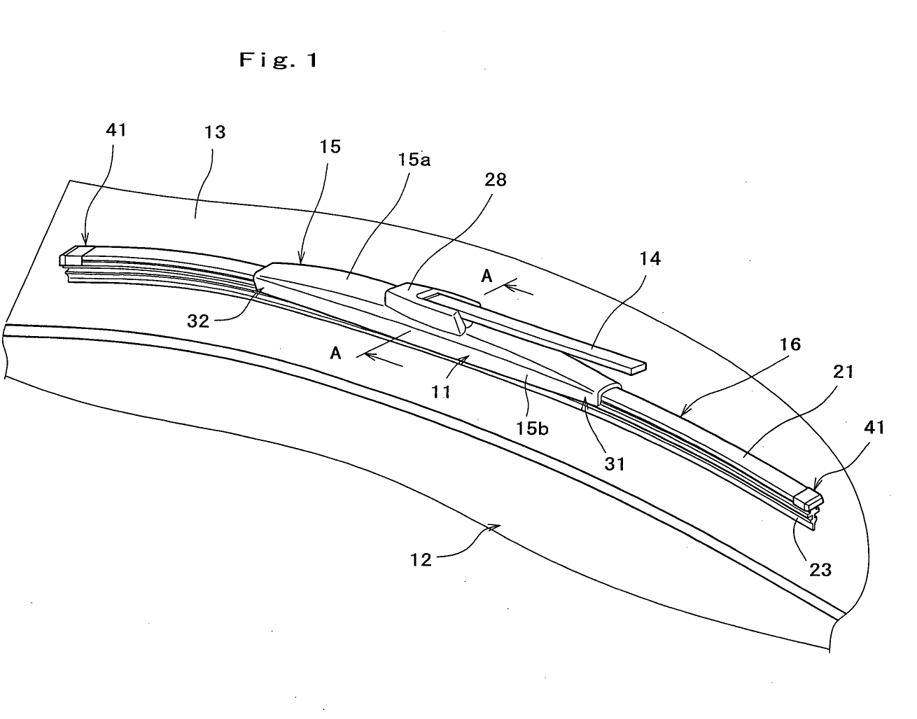

FIG. 1 is a perspective view showing a usage state of a wiper blade as an embodiment of the present invention. The wiper blade 11 shown in FIG. 1 is provided for wiping off adhering objects such as raindrops and spray from a car adhering to a front window glass 13, for example, (hereinafter, referred to as a window glass 13) of a vehicle 12.

This wiper blade 11 includes a rubber holder 15 attached to a tip end of a wiper arm 14 provided so as to swing on the vehicle 12 and a blade rubber 16 held by the rubber holder 15. The blade rubber 16 is in elastic contact with the window glass 13 by being applied with a pressure from the wiper arm 14 via the rubber holder 15. When the wiper arm 14 is swung (driven) by a wiper motor not shown, the wiper blade 11 reciprocates in a swinging manner on the window glass 13 together with the wiper arm 14 to wipe the glass surface.

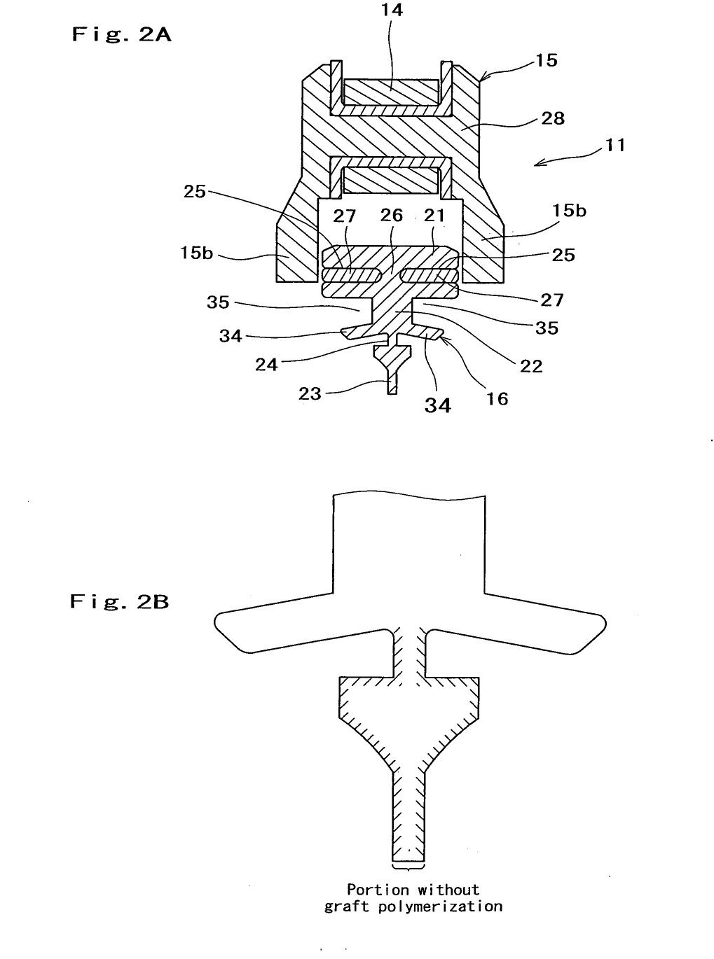

FIG. 2A is a sectional view along the A-A line of FIG. 1, and FIG. 2B is an enlarged view of a lip portion of FIG. 2A.

As shown in FIG. 2A, the blade rubber 16 used in this wiper blade 11 is formed into a bar shape with a section uniform in a longitudinal direction having a head portion 21, a joint portion 22 and a lip portion 23 continuous from the head portion 21 formed from natural rubber or synthetic rubber so that the lip portion 23 comes into contact with the window glass 13. The lip portion 23 is joined to the joint portion 22 via a neck portion 24 that is formed to be narrower in a wiping direction than the joint portion 22 and the lip portion 23. Accordingly, the lip portion 23 can tilt to the downstream side of the wiping direction with respect to the head portion 21 and the joint portion 22.

On both sides of the wiping direction of the head portion 21, fitting grooves 25 concave in the wiping direction are formed. These fitting grooves 25 extend in the longitudinal direction so as to reach one end from the other end in the longitudinal direction of the head portion 21. The fitting grooves 25 are arranged in parallel in the wiping direction in a state where they are isolated from each other by a partition 26. Then, in these fitting grooves 25, leaf spring members (vertebrae) 27 are fitted.

By punching out a plate member such as a steel plate, the leaf spring member 27 is formed into a flat plate with a length equivalent to that of the blade rubber 16, and is elastically deformable in a direction perpendicular to the window glass 13. Therefore, the blade rubber 16 to which the leaf spring members 27 are fitted is elastically deformable in a direction of changing the degree of curving in a direction perpendicular to the window glass 13, that is, with respect to the glass surface integrally with the leaf spring members 27. In the natural states of the leaf spring members 27, they are curved more greatly than the curvature of the window glass 13 in the elastically deformable direction, and accordingly, the blade rubber 16 to which the leaf spring members 27 are fitted are also curved more greatly than the window glass 13 in a state that it is apart from the window glass 13.

On the other hand, the rubber holder 15 is formed into a shape with a U-shaped section including a top wall 15a and a pair of side walls 15b from a resin material, and its length is set to be about half the blade rubber 16. At substantially the longitudinally middle portion of the top wall 15a, an attaching portion 28 is provided, and the rubber holder 15 is attached to the tip end of the wiper arm 14 in this attaching part 28.

At one longitudinal end of the rubber holder 15 (end close to the swing center of the wiper arm 14 when the wiper blade 11 is attached to the wiper arm 14), a holding portion 31 is provided, and at the other longitudinal end of the rubber holder 15, a holding portion 32 is provided.

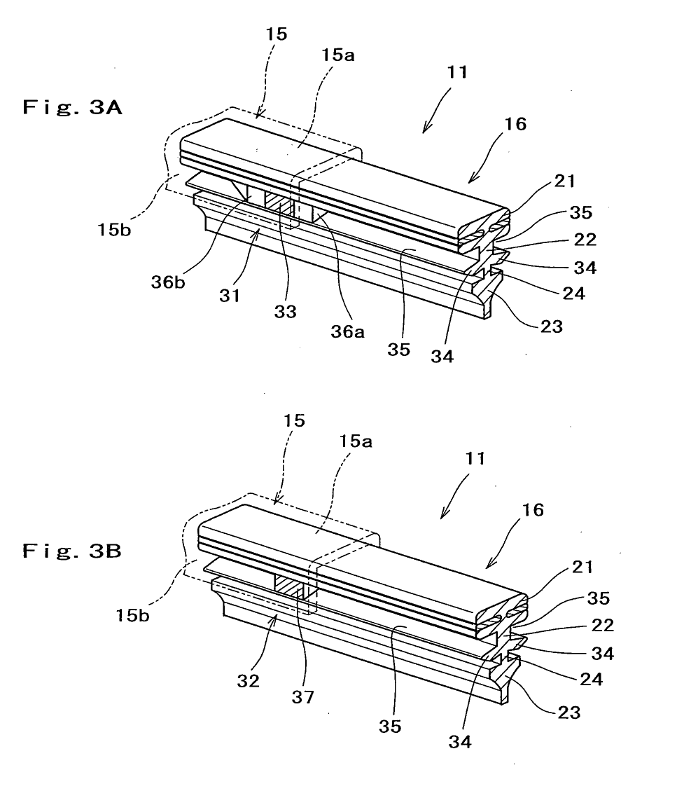

As shown in FIG. 3A, the holding portion 31 has a pair of holding claws 33 formed integrally with the side walls 15b (only the claw at one side is shown in the figure, however, the same holding claw 33 is also provided on the other side), and these holding claws 33 are formed into projections with rectangular sections projecting from side walls 15b in directions orthogonal to the longitudinal direction of the blade rubber 16 and in parallel to the wiping direction. On the other hand, between the head portion 21 and the lip portion 23 of the blade rubber 16, holding grooves 35 partitioned by the head portion 21 and arm portions 34 formed on the joint portion 22 are formed so as to extend longitudinally, and the holding claws 33 are engaged in the corresponding holding grooves 35, respectively. Specifically, the head portion 21 of the blade rubber 16 is sandwiched by the holding claws 33, both side walls 15b, and the top wall 15a, and accordingly, the head portion 21 is held by the holding portion 31.

In the holding groove 35, a pair of stoppers 36a and 36b that sandwich each holding claw 33 from the longitudinal direction are provided, and by these stoppers 36a and 36b, the holding claw 33 is restricted from moving in the direction along the holding groove 35. Specifically, at the holding portion 31, the blade rubber 16 is held by the rubber holder 15 in a state that the blade rubber 16 is positioned in the longitudinal direction.

Similarly, as shown in FIG. 3B, the holding portion 32 has a pair of holding claws 37 (only the claw on one side is shown in the figure, however, the same holding claw 37 is also provided on the other side) formed integrally with the respective side walls 15b, and these holding claws 37 are formed into projections with rectangular sections projecting from the side walls 15b in directions orthogonal to the longitudinal direction of the blade rubber 16 and in parallel to the wiping direction. The holding claws 37 are engaged in the corresponding holding grooves 35, respectively. Accordingly, the head portion 21 of the blade rubber 16 is sandwiched by the holding claws 37, both side walls 15b, and the top wall 15a, and held by the holding portion 32. The portion of the holding groove 35 corresponding to the holding portion 32 is not provided with the stoppers 36a and 36b, and the holding claws 37 are movable along the holding grooves 35.

Thus, in this wiper blade 11, the blade rubber 16 is provided with holding portions 31 and 32 at both ends in the longitudinal direction of the rubber holder 15 so that the blade rubber 16 is held by the two points of these holding portions 31 and 32. Therefore, when a pressure from the wiper arm 14 is applied to the rubber holder 15 via the attaching portion 28, this pressure is applied to the blade rubber 16 from the two points at both ends of the rubber holder 15, that is, from the holding portions 31 and 32 and both ends of the top wall 15a corresponding to the holding portions 31 and 32. Accordingly, the blade rubber 16 comes into elastic contact with the window glass 13.

The initial state of the rubber surface for graft polymerization is irradiated with an activating radiation source for activating the rubber surface, and as irradiation for generating radical active sites by activating the rubber surface, for example, radiation that induces activation represented by, for example, ultraviolet ray irradiation, plasma irradiation, electron beam irradiation, radiation (alpha beam, beta beam, and gamma beam) irradiation, ion beam irradiation, or corona discharge irradiation is applied, and from the radical active sites as starting points, graft polymerization reaction progresses. When applying pre-irradiation, irradiation is desirably performed in an atmosphere of nitrogen, and also, at the time of the graft polymerization reaction, bonding with a monomer in an atmosphere of nitrogen is desirable.

Further, when the activating radiation source is an electron beam, it is preferable that the absorbed dose thereof is not less than 10 kGy, and the reactive solution concentration of hydrophilic monomers in the graft polymerization is not less than 30 weight percent.

In the present invention, as a method for promoting graft polymerization reaction starting from generated radical active sites, there is a method using pre-radiation in which radical active sites are generated first by applying irradiation treatment to rubber and then graft polymerization is performed, and a method using simultaneous irradiation in which generation of radical active sites and graft polymerization are simultaneously performed. The present invention can be carried out by either method.

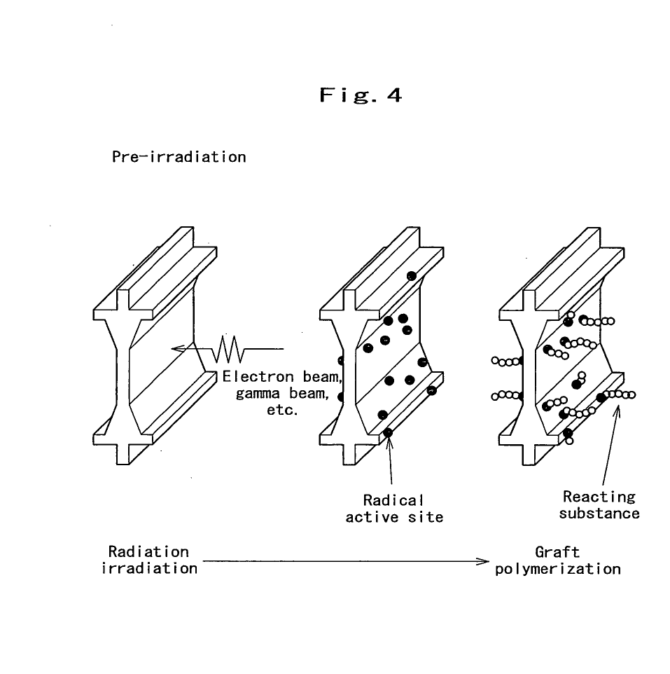

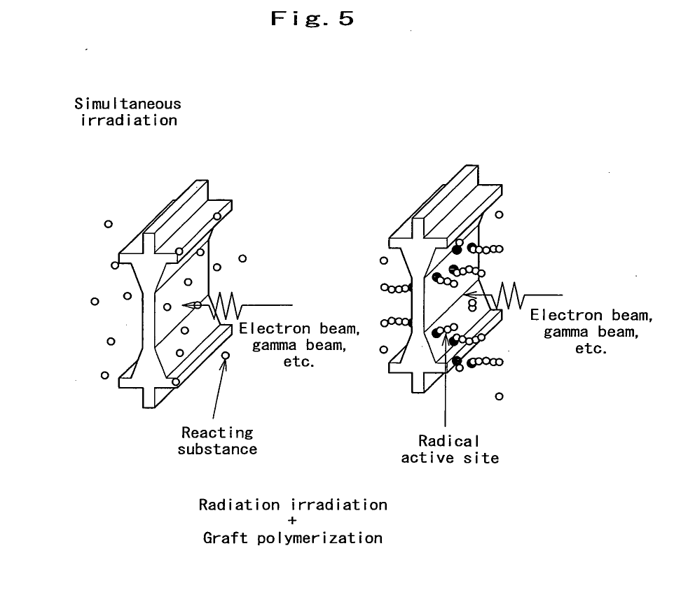

FIG. 4 is an explanatory view showing a reaction form of the pre-irradiation, and FIG. 5 is an explanatory view showing a reaction form of the simultaneous irradiation. In both of FIG. 4 and FIG. 5, only the lip portions of a blade rubber mold before being cut into a blade rubber, that is, a blade rubber mold molded so that a pair of blade rubber lip portions face each other are shown.

In the reaction process of the pre-irradiation, as diagrammatically shown in FIG. 4, irradiation of an electron beam, etc., for generating radical active sites is applied to rubber, and graft polymerization is performed starting from the generated radical sites, and in the reaction process of the simultaneous irradiation, as diagrammatically shown in FIG. 5, under the presence of reacting substances for graft polymerization, irradiation of an electron beam, etc., for generating radical active sites is applied to rubber to promote generation of the radical active sites and graft polymerization. In the simultaneous irradiation of the present invention, for example, in a state that monomers to be used for graft polymerization are made to adhere in advance to the surface of the blade rubber by coating or impregnation, the irradiation of an electron beam, etc., for generating radical active sites is performed. The absorbed dose is desirably 10 to 50 kGy in the case of the simultaneous irradiation, and 50 to 200 kGy in a deoxidized state in the case of pre-irradiation.

A hydrophilic monomer for producing a graft polymer is a reactive monomer having at least one of a vinyl group, an isopropenyl group, and an allyl group in a molecule, and in a molecule, having hydrophilic substituents or chemical bonds represented by a hydroxyl group, thiol group, carbonyl group, carboxyl group, aldehyde group, ketone group, amino group, epoxy group, cyano group, isocyanate group, nitro group, halogen group, sulfonyl group, phosphate group, ionic substituent, and ester bond, ether bond, amide bond, and urethane bond, or having a functional group into which at least one of the substituents or chemical bonds can be introduced by further reaction after graft polymerization.

Graft polymerization uses, as a reaction initiator, at least one of the chemical substances represented by peroxides, azo compounds, redox initiators, alkali metals, organic alkali metals, and Grignard reagents.

A gel-like substance with hydrophilic property is, for example, at least one hydrophilic monomer such as acrylic acid (AA), methacrylic acid (MAA), 2-hydroxyethyl methacrylate (HEMA), 2-hydroxyethyl acrylate (HEA), methyl methacrylate (MMA), ethyl methacrylate, and vinyl methacrylate, etc., and metal salts of these. These monomers can be used singly or by mixing a plurality of monomers of these as a monomer for a graft polymerization reaction.

The hydrophilic monomer is a reactive monomer having at least one of a vinyl group, an isopropenyl group, and an allyl group in a molecule to serve as an initiator, and in a molecule, having hydrophilic substituents or chemical bonds represented by a hydroxyl group, thiol group, carbonyl group, carboxyl group, aldehyde group, ketone group, amino group, epoxy group, cyano group, isocyanate group, nitro group, halogen group, sulfonyl group, phosphate group, ionic substituent, and ester bond, ether bond, amide bond, and urethane bond, or having a functional group into which at least one of the substituents or chemical bonds can be introduced by further reaction after graft polymerization.

The blade rubber is produced as a pair of blade rubber molds formed so that the lip portions face each other. Thereafter, the pair of blade rubber molds are cut at the lip portions to form a blade rubber. At this time, the pair of blade rubber molds are cut while graft-polymerized monomers adhere thereto, so that the surface treatment of graft polymerization is not applied to the cut surface (tip end face) of the blade rubber as shown in FIG. 2B. Normally, a window glass is wiped by an edge portion at the boundary between both side surfaces of the lip portion of the blade rubber and the cut surface, so that the window glass can be wiped by both side surfaces of the lip portion subjected to the surface treatment, and wiping of the window glass by the cut surface is avoided. In addition, irradiation of an electron beam, etc., for generating radical active sites and graft polymerization are not necessary on portions such as the head portion of the blade rubber mold which do not come into contact with the window glass, so that it is also allowed that the portions which are not irradiated with an electron beam, etc., of the blade rubber mold are masked and only necessary portions such as a lip portion of the blade rubber mold are irradiated with the electron beam, etc.

Next, an example will be described.

1. Grafting Experiment of Rubber Surface

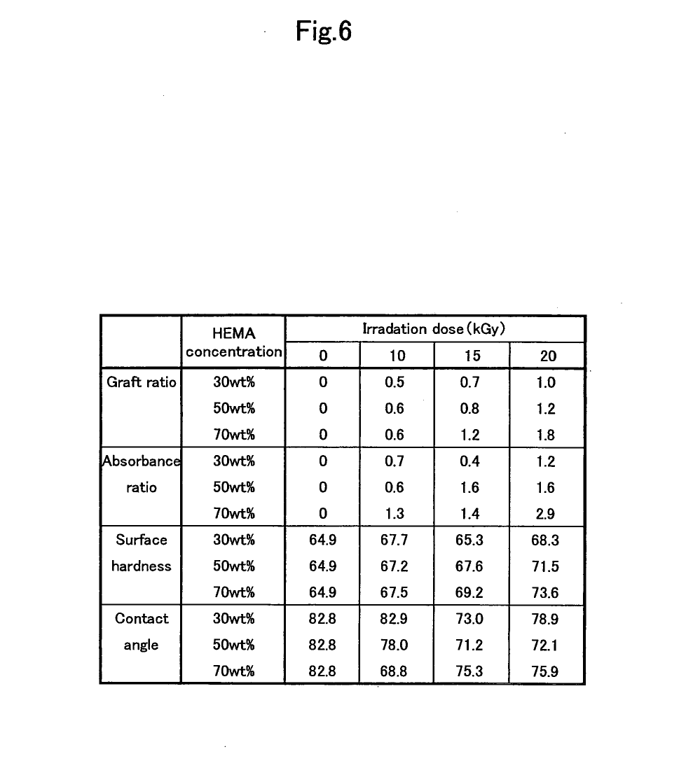

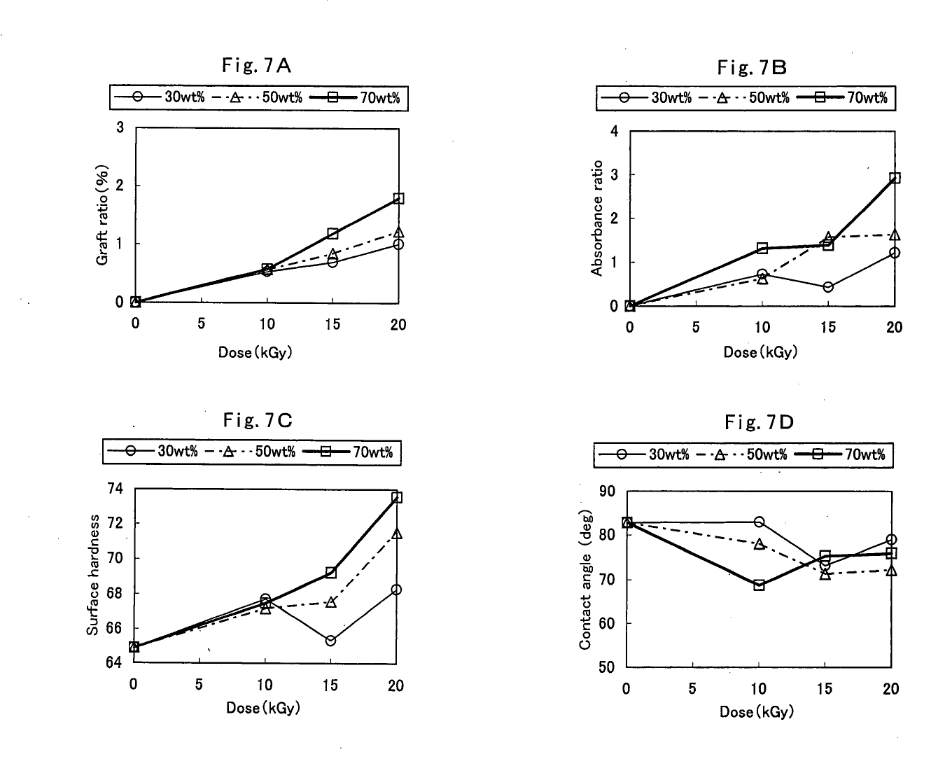

While crosslinked natural rubber (NR) was used as rubber, solutions containing 30, 50, and 70 weight percents of HEMA were prepared, and the rubber was impregnated with the HEMA solutions, and under a temperature condition of 40° C., these were reacted with each other for 3 hours by irradiating an electron beam with absorbed doses of 10, 15, and 20 kGy according to the simultaneous irradiation method. As irradiation conditions, 1 MeV and 1.06 mA were set. The results of measurements of the graft ratios, the absorbance ratios, the surface hardnesses, and the contact angles of these are shown in the table of FIG. 6 and the graphs of FIGS. 7A-7D. The absorbance ratios were measured at 1720 and 1375 cm⁻¹, and the graft ratios were calculated as:

graft ratio=100×(weight after grafting−initial weight)/initial weight.

According to the measurements, it was observed that as the absorbed dose increased, the graft ratio, the absorbance ratio, and the surface hardness increased, however, the contact angle tended to decrease.

2. Comparison and Examination of Surface Hardnesses

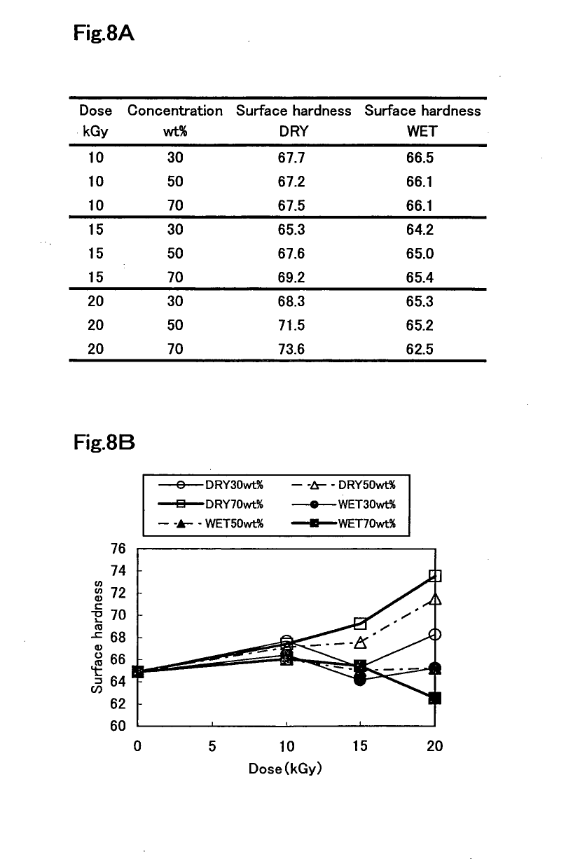

Next, it was examined how the surface hardnesses of the grafted rubber changed between a dry state and a wet (moistened) state. The surface hardness in the wet state is a result of measurement of the surface hardness after leaving it for 1 minute in a state wet with water. The results are shown in the table of FIG. 8A and the graph of FIG. 8B, and these figures show that the surface hardness of rubber graft-polymerized with HEMA tends to lower in a state wet with water. In this case, as the graft polymerization progresses, the surface hardness increases, however, at the same time, lowering in surface hardness due to water absorption also becomes greater, and as a result, as the graft polymerization progresses, the surface hardness difference between a dry state and a wet state becomes greater.

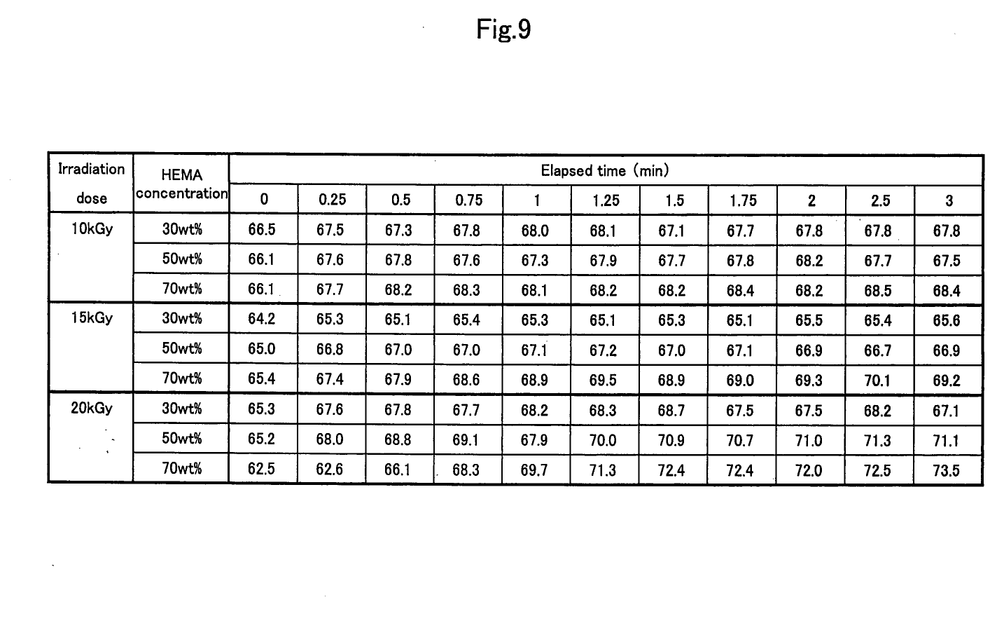

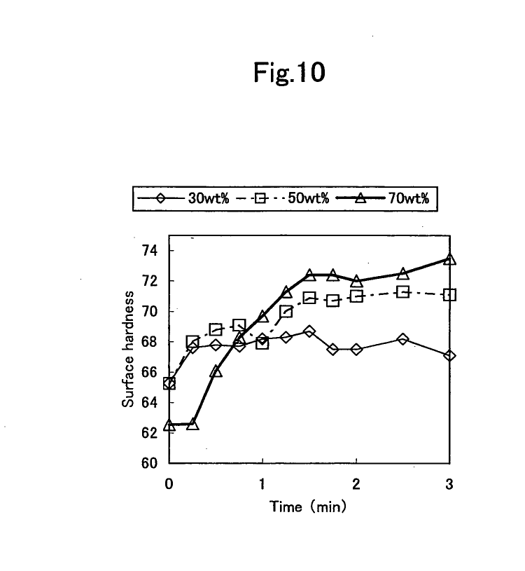

Further, the observed results of changes at the time of transition from a wet state to a dry state, that is, changes with time in surface hardness when leaving the rubber after extra moisture was removed from the wet state are shown in the table of FIG. 9 and the graph of FIG. 10. FIG. 10 shows the case where the absorbed dose was set to 20 kGy. These figures show that, in the case of transition from a wet state to a dry state, the surface hardness was restored to the hardness of the original dry state in 2 minutes.

3. Examination on Frictional Property

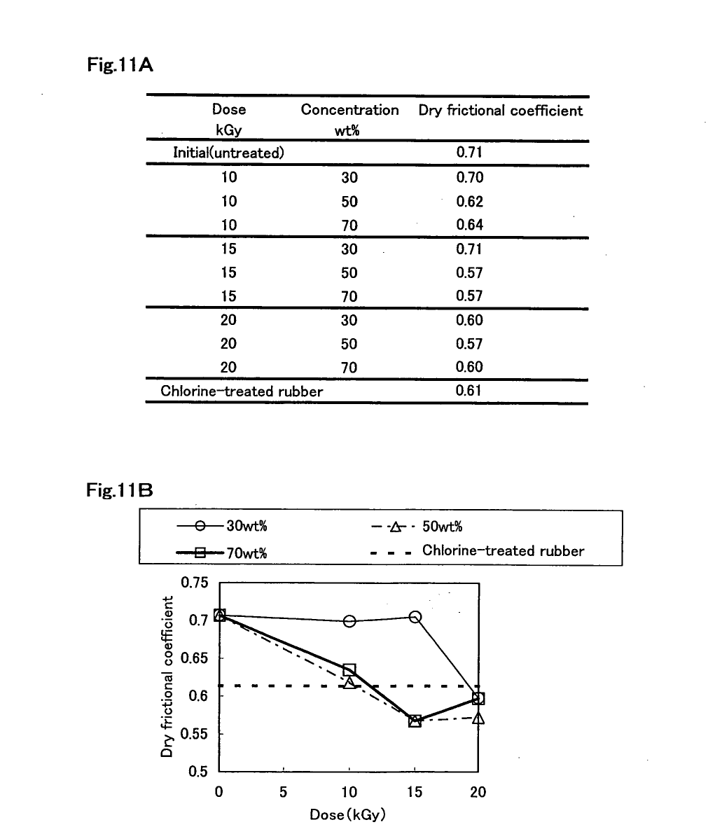

The frictional properties of the graft polymerized rubber are shown in FIG. 11A and the frictional properties in a dry state are shown in FIG. 11B, together with frictional properties of a chlorine-treated rubber. These figures show that the rubber graft-polymerized with HEMA changes in frictional coefficient according to the graft polymerization conditions such as the irradiation dose and monomer concentration, and depending on the conditions, the rubber graft-polymerized with HEMA can achieve a low friction equivalent to that of the existing chlorine-treated rubber (available on the market).

4. Examination on Wiping Performance

The HEMA graft-polymerized rubber was tested on the wiping performance according to a laboratory friction test as well as the existing chlorine-treated rubber. The test conditions are as follows.

Sample width: 10 mm

### Load: 15 gf

Friction velocity: 1.3 m/s
Sample inclination angle: 45 degrees

### Humidity: 25° C. 70% RH

Target material: Glass plate

Wiping index(%)=(wiping area−wiping line area)/wiping area×100

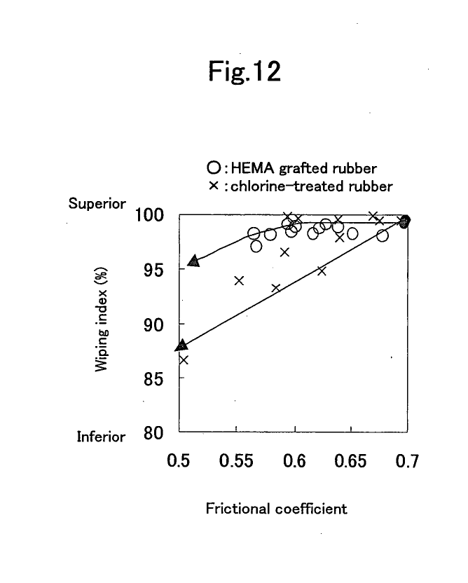

FIG. 12 is a graph showing the relationship between the frictional coefficient change according to surface treatment and wiping performance. According to this, it was confirmed that the wiping performance of chlorine-treated rubber became lower as the friction became lower (frictional coefficient became lower), and this result was the same as the experientially known result. On the other hand, it was confirmed that the wiping performance of the graft-polymerized rubber did not lower greatly in spite of the lower friction.

5. Examination on Wear Resistance

Last, the wear resistance was examined. The wearing test conditions were set as follows.

Sample width: 10 mm
Rotation speed: 103.5 rpm (80.2 cm/s)
Friction state: Dry
Drum: Glass drum

### Load: 15 gf

Temperature and humidity: atmosphere
Friction time: 2 h

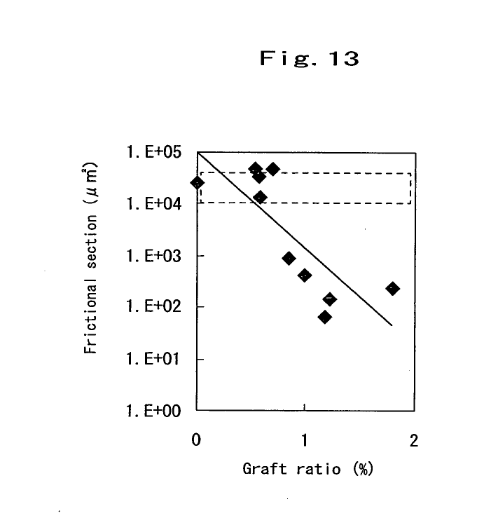

A graft showing the relationship between the graft ratio and the wearing section (wearing amount) of the graft-polymerized rubber is shown in FIG. 13.

Observing the relationship between the wearing section and the graft ratio, according to a graft ratio increase, the wearing section becomes smaller, and this result shows that the wear resistance is improved as the graft layer is produced.

The wearing section of the conventional chlorine-treated rubber is about 10000 to 50000 μm² as described in a dashed-like enclosure in FIG. 13, and in comparison with this, the wear resistance of the grafted rubber is more excellent than the chlorine-treated rubber. In addition, the treatment layer of the chlorine-treated rubber more easily separates as the treatment conditions become extreme. From these facts, it can be judged that the rubber obtained by radiation graft polymerization of HEMA is more excellent in wear resistance of surface treatment.

What is claimed is:

1. A rubber product for wiping comprising:
a hydrophilic gel-like surface treatment layer coated on at least a wiping surface of the rubber product, wherein the wiping surface is softer due to water absorption when moistened than when dried.

2. The rubber product for wiping according to claim 1, wherein a surface wiped by the wiping surface is a glass surface, and the hydrophilic gel-like surface treatment layer has a hydrophilic hydrogel layer.

3. A rubber for a wiper blade comprising:
a hydrophilic gel-like surface treatment layer coated on at least a wiping surface of the rubber, wherein the wiping surface is softer due to water absorption when moistened than when dried.

4. The rubber for the wiper blade according to claim 3, wherein a surface wiped by the wiping surface is a glass surface, and the hydrophilic gel-like surface treatment layer has a hydrophilic hydrogel layer.

5. The rubber for the wiper blade according to claim 3, wherein the wiping surface of the rubber is subjected to a hydrophilic gel-like surface treatment by forming active sites on the wiping surface of the rubber and reacting the active sites with a surface preparation agent.

6. The rubber for the wiper blade according to claim 3, wherein a hydrophilic gel-like surface treatment is applied by forming active sites in a surface preparation agent and reacting the active sites with the wiping surface.

7. The rubber for the wiper blade according to claim 3, wherein the hydrophilic gel-like surface treatment is a treatment with a gel-like substance with a hydrophilic property.

8. The rubber for the wiper blade according to claim 3, wherein a gel-like substance with a hydrophilic property of a surface preparation agent is chemically bonded to the wiping surface by graft polymerization.

9. The rubber for the wiper blade according to claim 8, wherein the gel-like substance with the hydrophilic property is a graft polymer using at least one hydrophilic monomer such as hydroxyethylmethacrylate, hydroxyethylacrylate, glycidyl methacrylate, acrylamide, methacrylic acid, acrylic acid, and metal salts of these.

10. The rubber for the wiper blade according to claim 9, wherein the hydrophilic monomer is a reactive monomer having at least one of a vinyl group, an isopropenyl group, and an allyl group in a molecule, and in the molecule, having hydrophilic substituents or chemical bonds represented by a hydroxyl group, thiol group, carbonyl group, carboxyl group, aldehyde group, ketone group, amino group, epoxy group, cyano group, isocyanate group, nitro group, halogen group, sulfonyl group, phosphate group, ionic substituent, and ester bond, ether bond, amide bond, and urethane bond, or having a functional group into which at least one of the substituents or chemical bonds can be introduced by further reaction after graft polymerization.

11. The rubber for the wiper blade according to claim 8, wherein an initial state of the wiping surface for graft polymerization is irradiated with an activating radiation source for activating the wiping surface.

12. The rubber for the wiper blade according to claim 11, wherein the wiping surface irradiated with the activating radiation source is graft polymerized with a hydrophilic monomer.

13. The rubber for the wiper blade according to claim 11, wherein the activating radiation source is a radiation source that evokes activation represented by alpha beam, beta beam, gamma beam, electron beam, ultraviolet ray, x-ray, laser beam, plasma, ion beam, and corona.

14. The rubber for the wiper blade according to claim 13, wherein, when the activating radiation source is an electron beam, an absorbed dose thereof is not less than 5 kGy, and a reactive solution concentration of the hydrophilic monomer in the graft polymerization is not less than 3 weight percent.

15. The rubber for the wiper blade according to claim 8, wherein the graft polymerization uses, as an initiating reagent, at least one of the chemical substances represented by peroxides, azo compounds, redox initiators, alkali metals, organic alkali metals, and Grignard reagents.

16. A method for producing a rubber for a wiper blade, comprising:
applying a hydrophilic gel-like surface treatment to at least a wiping surface of the rubber in order to make the wiping surface hard when dried and soft due to water absorption when moistened, wherein the hydrophilic gel-like surface treatment is a treatment with a gel-like substance with a hydrophilic property.

17. The method for producing the rubber for the wiper blade according to claim 16, wherein the hydrophilic gel-like surface treatment chemically bonds the gel-like substance with the hydrophilic property to the wiping surface by graft polymerization.

18. The method for producing the rubber for the wiper blade according to claim 17, wherein the graft polymerization is performed after irradiating the wiping surface for the graft polymerization with an activating radiation source for activating the wiping surface.

19. The method for producing the rubber for the wiper blade according to claim 18, wherein the wiping surface irradiated with the activating radiation source is graft polymerized with a hydrophilic monomer.

20. A wiper unit comprising:
a wiper arm;
a rubber holder attached to the wiper arm; and
a blade rubber that wipes a window glass surface of a vehicle,
wherein the blade rubber includes:
a head portion,
a joint portion that is formed continuously from the head portion and is held by the rubber holder, wherein the joint portion has a width in a wiping direction narrower than that of the head portion,
a neck portion that is formed continuously from the joint portion and is held by the rubber holder, wherein the neck portion has a width in the wiping direction narrower than that of the joint portion, and
a lip portion that is formed continuously from the neck portion, wherein at least a wiping surface of the lip portion is coated with a gel-like substance with a hydrophilic property that makes the wiping surface softer due to water absorption when moistened than when dried.

21. The wiper unit according to claim 20, wherein the gel-like substance with the hydrophilic property adheres to both side surfaces in the wiping direction of the lip portion of the blade rubber, and the gel-like substance with hydrophilic property is not adhering to a cut surface of the lip portion of the blade rubber.
